(19) United States
(12) Patent Application Publication
(10) Pub. No.: US 2009/0236360 A1
(43) Pub. Date: Sep. 24, 2009

(54) BULK PACKAGED MATERIAL AND METHODS OF PACKAGING AND DISPENSING MATERIAL

(76) Inventors: Michael Gefri, Granger, IN (US); Kenneth Forlenza, Flanders, NJ (US)

Correspondence Address: Henkel Corporation, 10 Finderne Avenue, Bridgewater, NJ, 08807, US

(21) Appl. No.: 12/187,412

(22) Filed: Aug. 7, 2008

Related U.S. Application Data
(63) Continuation-in-part of application No. 12/050,539, filed on Mar. 18, 2008.

(51) Int. Cl. B65D 35/00; B67D 5/00; B65D 35/14

(52) U.S. Cl. 222/1; 222/105; 220/495.06

(57) ABSTRACT

The invention provides packaging and shipping containers used to store and transport a wide variety of materials at substantially lower cost and with less waste.

This is a continuation-in-part of U.S. application Ser. No. 12/050,539, filed Mar. 18, 2008.

### FIELD OF THE INVENTION

The invention relates to an improved design for the bulk packaging of materials, including liquids, in particular viscous liquids. The packaging is well suited for use in the packaging, storing, shipping and dispensing of adhesives, including moisture curable hot melt adhesives, silicones, mastics, greases, pastes and the like.

### BACKGROUND OF THE INVENTION

Hot melt adhesives are solid at room temperature but, upon application of heat, melt to a liquid or fluid state in which form they are applied to a substrate. On cooling, the adhesive regains its solid form. The hard phase(s) formed upon cooling the adhesive imparts all of the cohesion (strength, toughness, creep and heat resistance) to the final adhesive. Curable hot melt adhesives, which are also applied in molten form, cool to solidify and subsequently cure by a chemical crosslinking reaction. An advantage of hot melt curable adhesives over traditional liquid curing adhesives is their ability to provide “green strength” upon cooling prior to cure. Advantages of hot melt curable adhesives over non-curing hot melt adhesives include improved temperature and chemical resistance.

The majority of reactive hot melts are moisture-curing urethane adhesives. These adhesives consist primarily of isocyanate terminated polyurethane prepolymers that react with surface or ambient moisture in order to chain-extend, forming a new polyurethane/urea polymer. Polyurethane prepolymers are conventionally obtained by reacting polyols with isocyanates. Cure is obtained through the diffusion of moisture from the atmosphere or the substrates into the adhesive, and subsequent reaction. The reaction of moisture with residual isocyanate forms carbamic acid. This acid is unstable, decomposing into an amine and carbon dioxide. The amine reacts rapidly with isocyanate to form a urea. The final adhesive product is a crosslinked material polymerized primarily through urea groups and urethane groups. Hot melt adhesives, particularly those known as “reactive” or “moisture-curing” hot melt adhesives have characteristics which make them well suited for many applications which require high strength bonds that will withstand harsh environmental conditions. One drawback with the use of these materials has been the need for extremely durable packaging, to provide a barrier to atmospheric exposure that would result in premature reaction of the product.

Bulk adhesive products are conventionally supplied to the user in metal pails or drums. While these containers have been the standard for some time, they do present disadvantages. The packaging is expensive, bulky and heavy, the weight of the drum itself adding substantially to shipment costs. Other disadvantages include challenges faced by the consumer regarding the proper disposal of metal pails and drums. There are generally high costs associated with disposal of metal containers, especially those that contain residual material. Also, drums are susceptible to damage during shipment and handling. Often, even minor damage to these containers renders them unusable.

There is a need in the art for a packaging container that provides a cost-effective means for packaging, storing, shipping and dispensing adhesives and other similar materials. The current invention addresses this need.

### SUMMARY OF THE INVENTION

It is an object of the invention to provide a storage and shipment container which is inexpensive to manufacture and use, and which can be easily and conveniently adapted for dispensing the material contained therein.

It is a further object of the invention to provide a storage and shipment container which creates less waste after use than containers currently used in the art.

One aspect of the invention provides a container for packaging, storing, shipping and dispensing a material, including but not limited to hot melt adhesives. While the invention will, for convenience, be described in terms of packaging a hot melt adhesive, such as a moisture curable hot melt adhesive, it is to be understood that the invention is not to be so limited.

One embodiment of the invention is directed to a packaged hot melt adhesive, the packaged adhesive being stored and shipped as a solid block of adhesive contained within a sealed flexible bag, such as a foil or plastic film or laminate (e.g., Mylar). In a preferred aspect of this embodiment the flexible bag containing said adhesive will preferably be contained in a rigid shell or container that will typically be in the form of a cylindrical tube, pail or drum. Examples of rigid containers are fiber drums and polyethylene liners. In one aspect of this embodiment, the packaged hot melt adhesive is a moisture curable hot melt adhesive. For ease and convenience of description, the flexible bag will hereinafter be referred to as a “Mylar™” or “foil” bag. It is to be understood that any chemically stable, inert, plastic film or laminate having high tensile strength, and that is preferably heat sealable, can be used to manufacture the bag, and the invention is not to be otherwise limited to the type of material used to prepare the bag.

In a another embodiment of the invention, the foil bag containing said adhesive is secured to a structure, which structure is adapted to securely engage the packaged adhesive during dispensing, and which is also used to stabilize and secure the bag during the filling of its contents.

Still another embodiment of the invention is directed to packaging a hot melt adhesive by forming a solid block of adhesive in a sealed foil bag, which solid block of packaged adhesive is further packaged within a rigid fiber or plastic shell or drum. The adhesive may be simultaneously packaged within the fiber drum during its packaging in the foil bag.

A further embodiment of the invention provides a method of dispensing a hot melt adhesive comprising obtaining a solid block of packaged hot melt sealed within a foil bag and contained within a rigid container, opening the sealed bag ending to expose the adhesive, folding the open bag ending over the ends of the rigid container, and dispensing the adhesive. In one embodiment the rigid container is a fiber shell or a plastic liner.

The invention also provides a method of dispensing a hot melt adhesive comprising obtaining a solid block of packaged hot melt sealed within a foil bag, inserting the solid block of packaged adhesive into a container present at the user site, opening the sealed bag ending to expose the adhesive, and dispensing the adhesive. In one aspect of this embodiment the solid block of packaged adhesive is secured to a structure, which structure provides stability, balance and/or support for dispensing the adhesive. The structure is preferably used to engage and hold the packaged adhesive during dispensing.

In one embodiment of this aspect of the invention the solid block of packaged adhesive is inserted into a reusable metal or fiber tube present at the user site, which tube is open on both ends, and the structure engages and holds the packaged adhesive within the tube during dispensing. Such tubes include but are not limited to clam shell-type enclosures.

Yet another embodiment, the sealed end of said solid block of packaged adhesive is secured to an inside surface of a cover or lid, which cover/lid is engagable with a container for dispensing the adhesive. A tubular container is placed over the block of packaged adhesive, rotated, and the cover/lid removed to allow opening of the adhesive seal and the dispensing of said adhesive.

### BRIEF DESCRIPTION OF THE DRAWING FIGURES

FIGS. 1-7 are provided for illustration purposes only, and are not drawn to scale.

FIGS. 1-3 show side cross section elevation views of an adhesive package for storing and dispensing adhesive in accordance with one embodiment of the invention.

FIG. 1 shows a sealed foil bag contained in a fiber shell.

FIG. 2, alternatively, shows (i) the package of FIG. 1 that has been opened in preparation for dispensing the contents of the bag and (ii) illustrates how the foil bag is positioned during the filling or packaging the bag with adhesive product prior to sealing the bag ending to form the package shown in FIG. 1.

FIG. 3 shows the packaged adhesive during the dispensing operation.

FIGS. 4-7 show various other embodiments in which the foil bag is attached to a structure that provides stability, balance and/or support for storage, transport and/or dispensing, or may be used to engage and hold the packaged adhesive when dispensing.

FIG. 4A is a side cross section elevated view of a packaged adhesive held by a closed clamshell tube.

FIG. 4B is a plan view cross section showing the clamshell tube in both open and closed positions.

FIG. 5 is a side cross section elevated view in which a sealed foil bag is engaged with a cylindrical tube open on both ends.

FIG. 6 is a side cross section elevated view showing an engaged packaged adhesive comprising a sealed foil bag contained within a plastic shell.

FIG. 7 is another embodiment of the invention in which the seal side of the foil bag is removably attached to a support structure.

### DETAILED DESCRIPTION OF THE INVENTION

The invention relates to containers for the storage, shipment and use of materials. Included is any liquid, viscous liquid, solid, or semi-solid material. Non-limiting examples include adhesives, pastes mastics silicones, and greases. Included are materials that are packaged in the liquid state and shipped in the solid state, such as a hot melt adhesive. The invention is particularly useful in the packaging of hot melt adhesives, including but not limited to moisture curing hot melt adhesives, also alternatively referred to herein as reactive hot melt adhesives. While the practice of the invention is particularly advantageous for use in the packaging of moisture curing hot melt adhesives, and the invention primarily will be hereinafter discussed in terms of the packaging of moisture curable hot melt adhesives, it will be understood that the packaging and transporting materials and that the methods of the invention are also useful for packaging transporting a dispensing other types adhesives, including other types of curable adhesives, such as radiation curable hot melt adhesives, and for other materials that are bulk packaged.

The term moisture reactive hot melt adhesive, moisture curable/curing hot melt adhesive and moisture curing urethane/polyurethane adhesives are used interchangeable herein. Moisture curing hot melt adhesives consist primarily of isocyanate-capped polyurethane prepolymers obtained by reacting diols (typically polyethers, polyesters and polybutadienes) with a polyisocyanate (most commonly methylene bisphenyl diisocyanate (MDI)). A stoichiometric imbalance of NCO to OH groups is required in order for moisture cure to proceed, cure being obtained through the diffusion of moisture from the atmosphere or the substrates into the adhesive and subsequent reaction of moisture with residual isocyanate.

The invention described herein provides the art with an alternative packaging design or container that can be used to store and ship a wide variety of materials, including a variety of adhesive products at a substantially lower cost and with less waste than what is currently used in the art.

Currently, moisture reactive adhesives are bulk packaged and shipped in sealed metal drums. The drums themselves are expensive and heavy, which adds to shipping costs. Upon receipt the customer/end user must open the sealed drum by relieving pressure and un-torquing the clamping ring. Commonly an adhesive is also present to further seal the container, which adhesive seal must also be cut or otherwise broken. If the drum has been damaged in transit i.e., dented during shipment, and thus is ‘out-of-round’ the end user will not be able to use its entire contents since the heated pump, platen and ram assembly used to melt and dispense the adhesive content will not be able to extend past the dent. Once the content of the drum has been substantially used and the drum is substantially empty, the drum constitutes waste material that must be properly disposed of. Typically the drum ends up in the landfill.

The packaging material and methods of the invention provides that art with a 100% recyclable drum that costs less, reduces the waste stream entering landfills, resists dents and substantially reduces or eliminates ‘out-of-round’ drums, is easy to open and easier to package, reduces “skins” and increases the fill weight.

A “rigid” container, drum or shell is used herein to mean that the manufactured container, drum or shell, in the free standing state, is capable of maintaining its shape without collapsing upon itself. Rigid containers may be flexible. A polyethylene container as used herein would be considered to be flexible yet rigid.

The term “shell” is used herein to mean a protective covering or coating that resists damage such as gashes, dents, or fractures that may occur during transportation.

The term “fiber” is meant to include fibrous material, such as cellulosic paper, paperboard, or cardboard.

In one preferred embodiment, the packaged adhesive comprises a block, slug or sausage of adhesive contained within a foil/polyester bag, such as for example a Mylar™ bag. The terms block, slug or sausage are used interchangeable and refer to a composition that is in solid form. In a preferred embodiment, a cylindrical block of material is used.

The bag is filled by pumping or pouring molten adhesive in the liquid state into the bag which, during the heating process, will typically be held within a mold or placed within an outer container, such as a fiber or plastic shell to assure that the adhesive contents remain in a desired predetermined shape and size required for use by the consumer. The atmosphere of the head space of the bag is purged either through infusion of dry, inert gas or through vacuum. The bag is then heat sealed to prevent moisture contamination. Enough space is left between the adhesive and the heat seal such that when the bag is opened the bag ending is long enough to overlap the side wall of any drum (e.g., fiber or plastic shell) in which it is contained or may be placed. Typically between about 12 to 17 inches will be sufficient. The adhesive is then allowed to solidify.

The manufactured dimension of the cylindrical slug will closely match the internal dimensions of the steel drum or pail that is used in the plant of the end user of the adhesive product for dispensing the adhesive. Such drums will typically range from about 2 liters (one-half gallon) to about 1000 liters in size. Typically drums will range in diameter from about 6 inches to about 60 inches and will be from about 10 inches to about 48 inches in height. Included are 25 kilogram (5 gallon drums), i.e., a conventional “Europail”.

The Mylar™ bag containing the slug of adhesive is supplied with an excess at the top which, when the bag is cut open, allows the excess to be folded over the outside of the drum.

For pail quantities, foil bags could be simply inserted into a standard open ended pail, due to their relative light weight and resulting ease of handling.

While the foil bag may be used for packaging, shipping and storage, the bag may desirably be inserted into a fiber or plastic shell, either before or after filling, and the bag with the outer shell is together used for packing, shipping and dispensing. Such packaging assures that the bag will remain in a desired shape for use and avoids any risk of adhesive flow that may result during transportation, e.g., when transported in a truck that is not climate controlled that may effect later use in the dispensing operation.

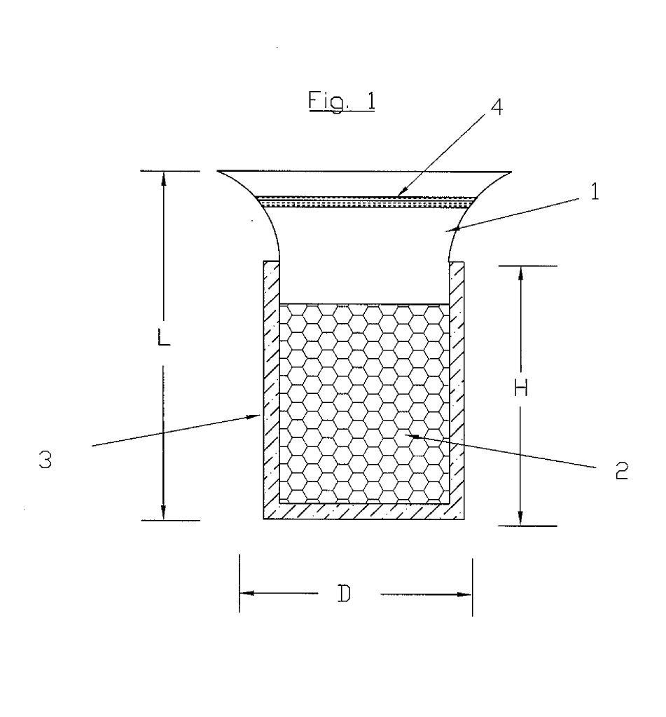

The fiber or plastic shells may be manufactured in any desired predetermined shape or size. In the embodiments shown in FIGS. 1-3, the shell/container (3) is a hollow, cylindrical drum having a cylindrical portion and a bottom. It is to be understood however that the container may have a shape other than a cylindrical shape. For example, the container may be square, hexagonal, octagonal, etc. The container will comprise a bottom wall and at least one side wall. In one preferred embodiment the container is cylindrical in shape and has a bottom wall and a continuous side wall. While the invention will herein after be described in terms of a cylindrical package, it is understood that the scope of the invention is not to be so limited.

Fiber containers or drums will preferably be 100% fiber and recyclable. The fiber container is preferable manufactured without the metal chimes at the base or open lip as is commonly used in the manufacture of fiber drums.

The drum is preferably 100% recyclable, or can be made recyclable with minimal time and effort. Conventional fiber drums known in the art for transporting various types of goods have a metal band or chime and are typically discarded after the contents housed therein are consumed because the fiber drums cannot easily be recycled. Recycling is difficult because the cellulosic portion of the drum must be separated from the metal portion of the drum to recycle either the fibrous portion or the metal portion. That operation can be complex and time consuming. Thus, a typical fiber drum owner ultimately pays to dispose of the empty fiber drum as refuse, rather than regaining some of the cost of the fiber drum by recycling.

Cylindrical drums may be manufactured using conventional core and tube winding processes included spiral and convolute or concentric winding. Preferred are multiply tubes. Typically drums for use in the practice of the invention will be about an eighth of an inch in thickness (about 8 plies).

While not required, the shell may preferable also be provided with an easily removable lid or cover to keep debris out during shipment so that the bag ending will be free of contamination when opened. A simple telescoping lid that is removed and then added to the plant recyclables is one preferred embodiment.

Following use of the adhesive product, the Mylar bag is removed from the container and thrown away. The fiber shell/drum is then added to the plants' recyclables. While the fiber drum used in the practice of the invention is recyclable, it will be appreciated that due to the presence of the foil bag, the inside of the drum stays clean. As such the adhesive residue can be discarded along with the bag, leaving a clean drum that can be reused for the same, or for another purpose, rather than being recycled.

In another embodiment of the invention an adhesive slug packaged in a Mylar bag is contained within a semi-rigid plastic vessel commonly known as a drum liner. This entire assembly is delivered to the site user. Adhesive is then dispensed at the site with the aid of a clamshell enclosure which is secured to the dispensing equipment.

In the dispensing and application of molten hot melt adhesive at the user site location, the adhesive is commonly heated to an elevated temperature sufficient to cause the adhesive to melt and to attain a viscosity compatible with dispensing in common hot melt dispensing equipment. Temperatures ranging from at least 150° F. up to 325° F. are common. Such temperatures cause the adhesive, once applied, to develop a bond rapidly, often within 100-200 seconds. Most commonly, hot melt isocyanate containing adhesives are used with heated platen melters that dispense the adhesive from cylindrical containers such as five gallon pails, ten gallon fiber board containers, fifty-five gallon drums, etc. This equipment typically consists of an apparatus which extrudes the adhesive from the pail. A heated platen contacts adhesive in the pail, heats the surface of the adhesive until molten, wherein a hose installed in the platen removes the heated molten adhesive to an extruder nozzle which applies the adhesive to a use location. Current manufacturers of heated platen type isocyanate dispensing equipment are Nordson, model number 5506, and Graco Thermoflow 200.

It will be appreciated that the containers of the invention can be used with unheated platens when the packaged and shipped contents remain liquid, viscous, or semisolid, following packaging, and require no heat to melt or otherwise alter the contents so that they can be readily pumped, dispensed, applied and/or used. Nonlimiting examples of such materials include paste and grease.

While the packaging of the invention may be utilized with current dispensing equipment—i.e., a heated or unheated platen type dispenser, the invention is not limited to current equipment of the exact dimensions. Furthermore, while the preferred embodiment describes the use of an all fiber drum due to its completely recyclable, other types of drums being comprised of other materials are not excluded.

One embodiment of the invention provides a packaged hot melt adhesive. The packaged adhesive comprises a solid block of adhesive contained within a sealed foil bag, which foil bag is contained within in a rigid container. In one preferred aspect the rigid container is cylindrical and at least one end of the cylindrical container is closed.

In a preferred embodiment, the adhesive is a moisture curable hot melt adhesive.

The packaged adhesive in the foil bag is sealed, preferable heat sealed.

In a preferred aspect of this embodiment the sealed foil bag is contained in a fiber shell, more preferably the shell is a 100% fiber drum. In another preferred embodiment, the sealed foil bag is contained in a plastic shell. The plastic shell may, if desired, be secured to a structure, which structure is adapted to securely engage and stabilize the packaged adhesive during shipment and/or dispensing of the packaged adhesive.

Another embodiment of the invention is directed to a packaged hot melt adhesive, the packaged adhesive comprising a solid block of adhesive contained within a sealed foil bag, which foil bag is secured to a structure, which structure is adapted to securely engage and stabilize the packaged adhesive during the filling and/or dispensing of the packaged adhesive.

The invention also provides a method of packaging, storing transporting and dispensing an adhesive. The method comprises forming a solid block of packaged hot melt adhesive by pumping or pouring molten adhesive into a foil bag and sealing the bag to form a solid block of packaged adhesive, transporting the adhesive to the site of the end use consumer (also referred to as the user site or the plant site), opening the sealed foiled bag, and dispensing the adhesive.

The invention also provides a method of dispensing a hot melt adhesive comprising obtaining a solid block of packaged hot melt adhesive sealed within a foil bag and contained within a rigid container, opening the sealed bag ending to expose the adhesive, folding the open bag ending over the ends of the rigid container, and dispensing the adhesive, e.g., by attaching/inserting the end users heated pump, platen and ram into the open end of the bag. In one embodiment the rigid container is a fiber shell or a plastic liner.

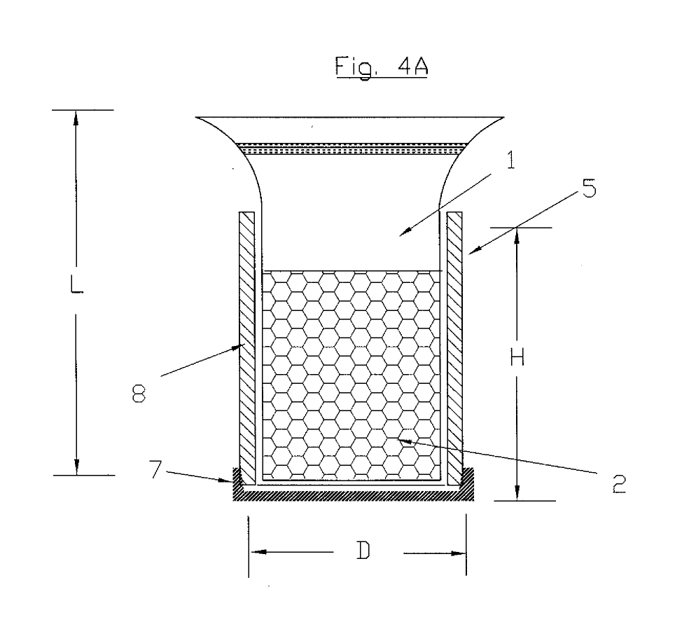

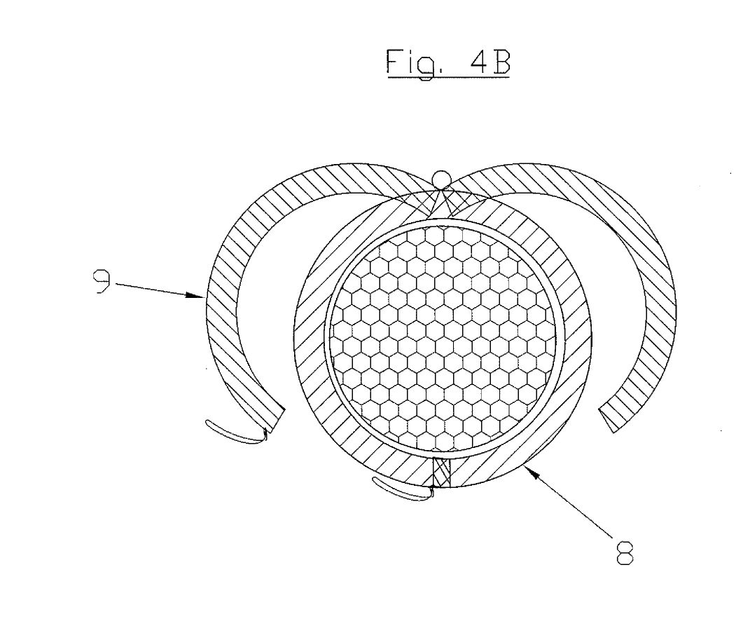

The invention also provides a method of dispensing a hot melt adhesive comprising obtaining a solid block of packaged hot melt adhesive sealed within a foil bag, inserting the solid block of packaged adhesive into a container, preferable a reusable container, that is present at the plant/user site, opening the sealed bag ending to expose the adhesive, and dispensing the adhesive. In one aspect of this embodiment the solid block of packaged adhesive is secured to a structure, such as with a clamp ring, which structure provides stability, balance and/or support for dispensing the adhesive. The structure is preferably used to engage and hold the packaged adhesive during dispensing. A “structure” of the type contemplated for use in the practice of the invention is illustrated in FIGS. 4A and 5-7, and is also referred to herein as an inverted cover or lid. Such a structure is perpendicular to the ground and has an upwardly extending side wall or lip that serves to guide or otherwise properly locate and/or center the open ended tube or clamshell tube so that it engages and is held securely during filling or dispensing of the adhesive. While the drawing figures illustrate a structure having one continuous side wall or lip, it will be appreciated that equivalent alternative structures, including those having multiple upwardly extending spokes or guide arms in place of the single side wall, are encompassed by the invention. In one embodiment of this aspect of the invention the solid block of packaged adhesive is inserted into a metal or fiber tube, which tube is open on both ends, and the structure engages and holds the packaged adhesive within the tube during dispensing. Such tubes include clam shell-type enclosures. The tubes are present at the user site and may be reused.

In one embodiment, the solid block of packaged adhesive is secured at the sealed end to an inside surface of a cover or lid, which cover/lid is engagable with a container for dispensing the adhesive. A tubular container present at the user site is placed over the block of packaged adhesive, rotated, and the cover/lid removed to allow opening of the adhesive seal and the dispensing of said adhesive.

FIGS. 1-7, which are not to scale, are illustrative of several embodiments of the invention.

FIGS. 1-3 show side cross section elevation views of an adhesive package for storing and dispensing adhesive in accordance with one embodiment of the invention, and which uses a fiber shell or drum that is typically about 2 feet in diameter (D) and 3 feet in height (H).

FIG. 1 shows a sealed Mylar bag (1) containing a solid block of adhesive (2). The bag, which is about 4 feet long (L), is contained within a fiber shell or drum (3). The Mylar bag is heat sealed shut (4).

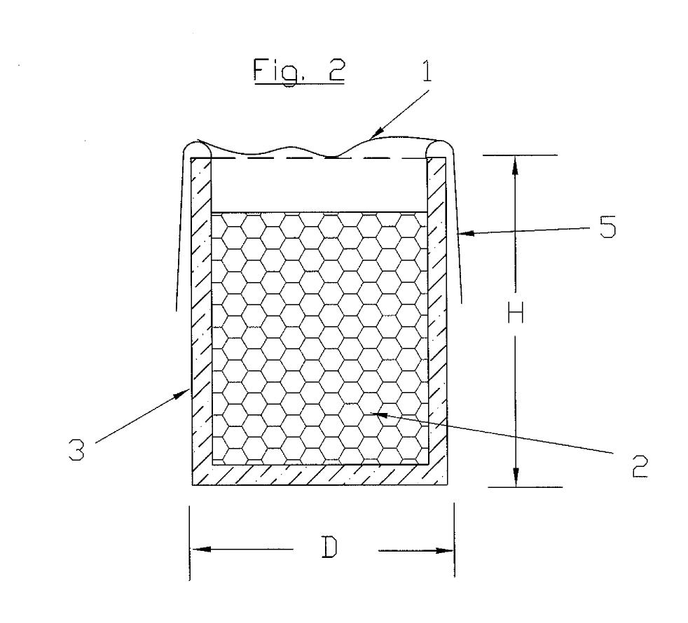

FIG. 2 shows the package of FIG. 1 that has been opened in preparation for dispensing the contents of the bag. FIG. 2 shows the drum of FIG. 1 after the seal has been broken by cutting the foil bag under the area of the heat seal to access the contents of the Mylar bag. The top of the bag has been opened and the bag endings (5) folded over the side wall of the fiber drum (3).

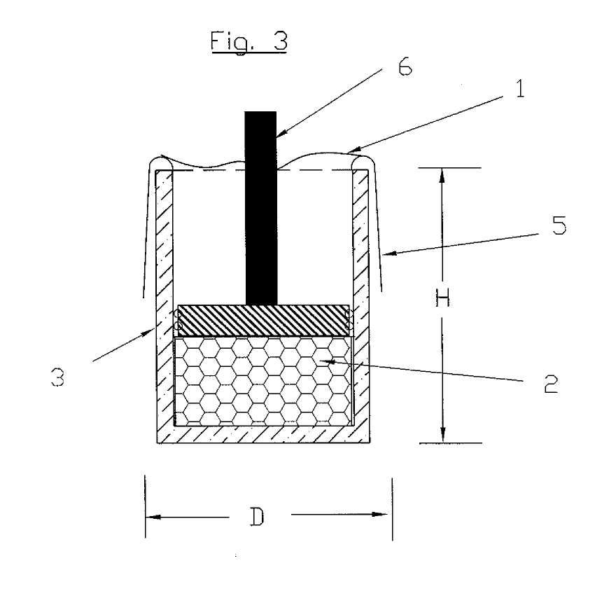

FIG. 3 shows the packaged adhesive during the dispensing operation. FIG. 3 shows the drum of FIG. 2 following insertion of a heated pump, platen and ram (6) into the open end of the bag/drum.

FIGS. 4-7 show various other embodiments in which the Mylar bag is attached to a structure that provides stability, balance and/or support for storage, transport and/or dispensing, or may be used to engage and hold the packaged adhesive when dispensing.

FIG. 4A is a side cross section elevation view of an adhesive packaged in a Mylar bag (1) with attached support structure (7). The packaged adhesive is held by a closed clamshell tube (8) present at the user site that is open at both ends, the bottom end of which is engaged with the support structure (7).

FIG. 4B is an plan view cross section showing the clamshell tube in both open (9) and closed (8) positions.

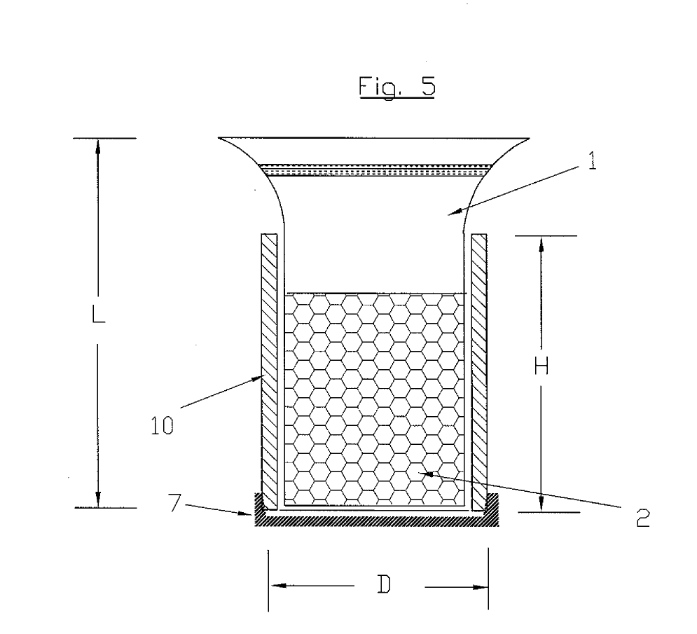

FIG. 5 is a side cross section elevation view in which a sealed Mylar bag (1) with attached support structure (7) has been inserted into a cylindrical tube (10) open on both ends (located at the user site), one end of which is engaged with the support structure (7). The open ended tube may be made of steel or may be made of fiber.

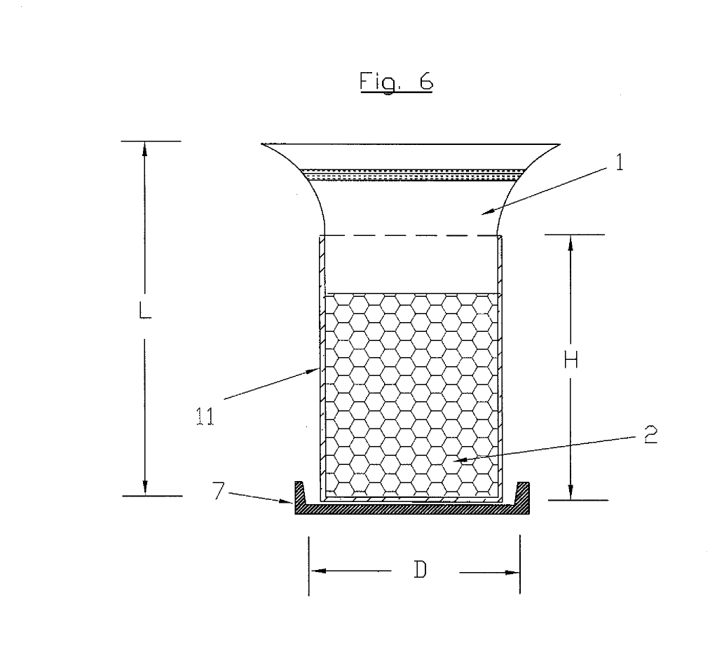

FIG. 6 is a side cross section elevation view showing an engagable packaged adhesive comprising a sealed Mylar bag contained within a plastic shell (11) with attached support structure (7).

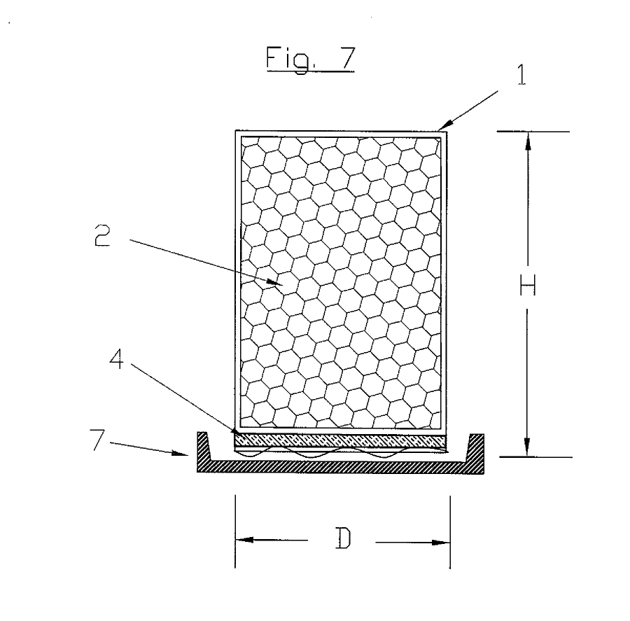

FIG. 7 is a side cross section elevation view of another embodiment of the invention in which the seal side of the Mylar bag is in contact with the support structure.

In the embodiment shown in FIG. 7, the bag is placed in a reusable performed mold or drum, filed with adhesive and then heat sealed. The side of the bag that has been sealed is attached to a support structure/lid. The support structure may be steel, fiber or plastic held in place with, for example, the use of a clamp ring. The package is then transported to the user site. At the user site, a cylindrical open ended tube or drum, such as a steel drum, is placed over the container, the support structure/lid is clamped to the drum, the drum is inverted, and the support structure/lid disengaged and removed. The sealed bag ending is open and the adhesive is ready for dispensing.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. A packaged material contained within a sealed flexible bag, which bag is contained within in a rigid container.

2. The packaged material of claim 1, which material is a solid, a liquid, a viscous liquid or a semisolid material.

3. The packaged material of claim 1, which material is a solid block of a moisture curable reactive hot melt adhesive.

4. The packaged material of claim 1 wherein the bag is heat sealed.

5. The packaged material of claim 1 wherein said rigid container is a fiber shell.

6. The packaged material of claim 5 wherein the fiber shell is 100% fiber.

7. The packaged material of claim 1 wherein said rigid container is a plastic shell.

8. The packaged material of claim 5 or 7 wherein said rigid container is cylindrical.

9. The packaged material of claim 8 where at least one end of the cylindrical container is closed.

10. The packaged material of claim 7 wherein said plastic shell is secured to a structure, which structure is adapted to securely engage and stabilize the packaged material during dispensing of the packaged material.

11. A packaged material contained within a sealed foil bag, which foil bag is secured to a structure, which structure is adapted to securely engage and stabilize the packaged material during filling and dispensing of the packaged material.

12. A packaged material contained within a sealed bag, which bag is secured at the sealed end thereof to an inside surface of a cover, which cover is engagable with a container for dispensing the material.

13. A method of dispensing a material comprising:
obtaining a packaged material that is sealed within a bag, which bag is contained within a rigid container having at least one open end,
opening the sealed bag ending to expose the material,
folding the open bag ending over an open end of the rigid container,
inserting a platen into an open end of the rigid container, and
dispensing the material.

14. The method of claim 13 wherein the platen is heating during dispensing

15. The method of claim 13 wherein the rigid container is a fiber shell or a plastic liner.

16. A method of dispensing a material comprising:
obtaining a packaged material that is sealed within a bag,
inserting the packaged material into an open end of a container,
opening the sealed bag ending to expose the material, and
dispensing the material.

17. The method of claim 16 wherein the container is a cylindrical tube having two open ends.

18. The method of claim 16 wherein packaged material is secured to a structure, which structure provides stability, balance and/or support for dispensing the material.

19. The method of claim 18 wherein said structure is used to engage and hold the packaged material during dispensing.

20. The method of claim 19 wherein said packaged material is inserted into a metal or fiber tube, which tube is open on both ends, and said structure engages and hold the packaged material within the tube during dispensing.

21. The method of claim 20 wherein said tube is a clam shell enclosure.

22. The method of claim 16 where the bag is secured at the sealed end thereof to an inside surface of a cover, which cover is engagable with a container for dispensing the material.

23. The method of claim 22 wherein a tubular container is placed over the packaged material, the cover secured to the container, the container is rotated, and the cover removed to allow opening of the sealed end and the dispensing of said material.
